(19) United States
(12) Patent Application Publication
(10) Pub. No.: US 2025/0208860 A1
(43) Pub. Date: Jun. 26, 2025

(54) INFORMATION PROCESSING DEVICE, INFORMATION PROCESSING METHOD, AND RECORDING MEDIUM

(71) Applicant: NEC Corporation, Tokyo (JP)

(72) Inventors: Yoshio KAMEDA, Tokyo (JP); Keita SAKUMA, Tokyo (JP); Ryuta MATSUNO, Tokyo (JP); Masakazu HIROKAWA, Tokyo (JP)

(73) Assignee: NEC Corporation, Tokyo (JP)

(21) Appl. No.: 18/967,898

(22) Filed: Dec. 4, 2024

(30) Foreign Application Priority Data
Dec. 26, 2023 (JP) 2023-219312

(51) Int. Cl. G06F 8/71; G06F 8/41

(52) U.S. Cl. CPC G06F 8/71; G06F 8/433

(57) ABSTRACT

In an information processing device, a data acquisition means acquires change history data concerning a change of software. A prompt acquisition means acquires a prompt which is described and instructs to create a comprehension table based on the change history data. A table creation means interprets the prompt using a natural language model and creates a comprehension table based on the change history data. A storage means stores the comprehension table in a storage unit.

### TECHNICAL FIELD

This disclosure relates to a development support of software.

### BACKGROUND ART

Git is known as a system that is used if several users cooperate to develop software. Git is a distributed versioning system for recording and tracking change history such as source codes of programs. Patent Document 1 discloses a software-development technique using Git.
Patent Document 1: Japanese Patent Application Laid-Open under No. 2022-104700

### SUMMARY

In a case where software is jointly developed by two or more users, a history of changes and edits made by individual users can be kept by using Git (trademark), etc. However, if the number of updates increases, it is necessary to track a large number of change histories in order to confirm a purpose and explanation of each change. The same is true for a software development by a single user if the number of changes is large or time has elapsed since the latest update.

One object of the present invention is to organize and manage information on a change history in the software development.

According to an example aspect of the present invention, there is provided an information processing device comprising:
at least one memory configured to store instructions; and
at least one processor configured to execute the instructions to:
acquire change history data concerning a change of software;
acquire a prompt which is described and instructs to create a comprehension table based on the change history data;
interpret the prompt using a natural language model and create a comprehension table based on the change history data; and
store the comprehension table in a storage unit.

According to another example aspect of the present invention, there is provided a n information processing method performed by a computer and comprising:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.

According to still another example aspect of the present invention, there is provided a non-transitory computer-readable recording medium storing a program causing a computer to execute processing of:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.

### Effect

According to the present disclosure, it is possible to organize and manage information on a change history in a software development.

### BRIEF DESCRIPTION OF THE DRAWINGS

FIG. 1 illustrates the entire configuration of a development support system.

FIG. 2 is a block diagram illustrating a hardware configuration of a terminal device.

FIG. 3 is a block diagram illustrating a hardware configuration of a server device.

FIG. 4 is a block diagram illustrating a functional configuration of the server device.

FIG. 5 illustrates an example of a folder configuration of a machine learning project of a target.

FIG. 6 illustrates an example of a release note comprehension table.

FIG. 7 illustrates an example of a commit history comprehension table.

FIG. 8 illustrates an example of a branch history comprehension table.

FIG. 9 illustrates an example of a folder structure comprehension table.

FIG. 10 illustrates an example of a dependency comprehension table.

FIG. 11 illustrates an example of a prompt which indicates to create a comprehension table.

FIG. 12 illustrates an example of the prompt which indicates to create the comprehension table.

FIG. 13 is a flowchart of a comprehension table creation process.

FIG. 14 illustrates an example of a question and an answer concerning software of a target.

FIG. 15 is a block diagram illustrating a functional configuration of an information processing device of a second example embodiment.

FIG. 16 is a flowchart of a process performed by the information processing device of the second example embodiment.

### EXAMPLE EMBODIMENTS

Preferred example embodiments of the present disclosure will be described with reference to the accompanying drawings.

### First Example Embodiment

### [Overall Configuration]

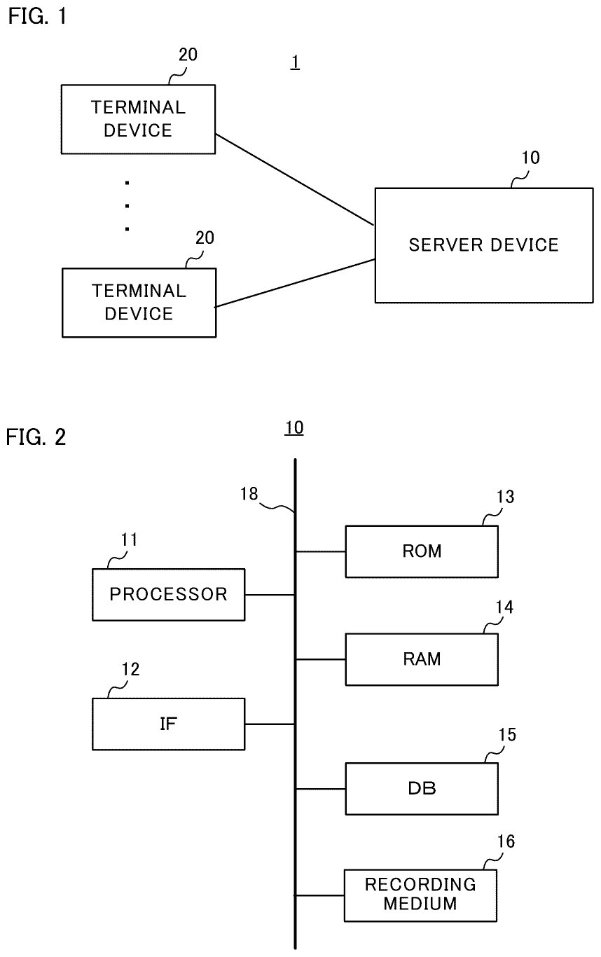

FIG. 1 shows an overall configuration of a development support system of software (hereinafter, simply referred to as the “development support system”) to that an information processing device according to the present disclosure is applied. Software developers (hereinafter also referred to simply as “users”) change or edit program code during a software development. In the present example embodiment, it is assumed that a plurality of users cooperate to develop software using Git.

As shown in FIG. 1, the development support system 1 includes a server device 10 and a plurality of terminal devices 20. The server device 10 and each of the terminal devices 20 can communicate via a wired or wireless network.

The server device 10 manages a remote repository in Git. Although the details will be described later, the server device 10 creates and manages an understanding table based on change history data acquired from the remote repository based on user instructions.

The terminal device 20 is operated by a user who develops the software. The user creates a local repository on the terminal device 20 and makes necessary changes and edits such as source codes of the program. The user then registers the changed files and directories with the server device 10. This operation is called commit. When the user performs a commit, the commit history recording the difference from the previous commit to the present is generated in the remote repository in the server device 10. The software development by a plurality of users is advanced by each user changing and editing his/her own responsibility and committing to the local repository of the server device 10. The commit history is an example of a software change history.

As the plurality of users make changes to the software, the server device 10 accumulates a plurality of change histories. By referring to the change history stored in the server device 10, each user can know the contents of the changes made by themselves or other users. However, tracking changes becomes complicated in a case where the number of change histories becomes large or in a case where rules for describing change histories are not standardized. Therefore, in the present example embodiment, the change history data stored in the server device 10 is arranged using a natural language model to generate an understanding table, and stored in a database or the like of the server device 10. Specifically, the server device 10 generates a comprehension table described in a natural language from the change history data using the natural language model and stores it in a database. Accordingly, it is possible for the user to easily obtain information on changes and edits which have been made in the past by making a query in the natural language to the server device 10.

Although the details will be described later, the server device 10 includes the natural language model capable of interpreting the natural language. The user transmits a prompt described in the natural language to the server device 10. In this case, the user includes in the prompt a designation of the change history data to be a target and an instruction for creating a comprehension table. The “prompt” refers to an instruction sentence to a generative AI (Artificial Intelligence) that includes the natural language model or the like. The server device 10 receives the prompt, and interprets the prompt using the natural language model to recognize the designation of the change history data and the instruction for creating the comprehension table by the user. The server device 10 creates the comprehension table from the change history data using the natural language model and stores the created comprehension table in a database.

### [Natural Language Model]

In the following, the natural language model will be described. The natural language model is a model that learns a relationship between words in a sentence, and generates a relevant string concerning a target string from the target string. By using the natural language model that learns sentences and texts of various contexts, it is possible to generate the relevant string with appropriate content concerning the target string. For instance, a case where the natural language model is used in a question and answer will be described. In this case, the natural language model accepts an input of a question “What kind of country is Japan?” as the target string, and generates “Japan is an island country in the northern hemisphere . . . ” as the answer to the question.

A learning method of the natural language model is not particularly limited, but may be a model that is trained to output at least one sentence including an input string as an example. For instance, the natural language model may be a GPT (Generative Pre-Training) that outputs a sentence containing the input string by predicting a string with a high probability of following the input string. Alternatively, the natural language model such as T5 (Text-to-Text Transfer Transformer), BERT (Bidirectional Encoder Representations from Transformers), ROBERTa (Robustly optimized BERT approach), and ELECTRA (Efficiently Learning an Encoder that Classifies Token Replacements Accurately) can be used. In the present example embodiment, a large-scale language model may be used as the natural language model. Also, the natural language model may be capable of accessing the Internet or other specialized knowledge bases to obtain information.

### [Hardware Configuration]

### (Server Device)

FIG. 2 is a block diagram illustrating a hardware configuration of the server device 10. As illustrated in FIG. 2, the server device 10 includes a processor 11, an interface (IF) 12, a ROM (Read Only Memory) 13, a RAM (Random Access Memory) 14, a database (DB) 15, and a recording medium 16. These components are mutually connected, for instance, through a bus 18.

The processor 11 is a computer such as a CPU (Central Processing Unit), and controls the entire server device 10 by executing a program prepared in advance. Specifically, the processor 11 may be a CPU, a GPU (Graphics Processing Unit), a DSP (Digital Signal Processor), a MPU (Micro Processing Unit), an FPU (Floating Point number Processing Unit), a PPU (Physics Processing Unit), a TPU (Tensor Processing Unit), a quantum processor, a microcontroller, or a combination thereof.

Also, the processor 11 loads the program stored in the ROM 13 or the recording medium 16 to the RAM 14, and executes the processes coded in the program. The processor 11 acts as part or all of the server device 10.

The IF 12 transmits and receives data to and from an external device. Specifically, the server device 10 transmits and receives data to and from the terminal device 20 through the IF 12.

The ROM 13 stores various programs executed by the processor 11. The RAM 14 is used as a working memory during various processes performed by the processor 11. The DB 15 stores the change history data created by the user while developing the software. Moreover, the DB 15 stores various comprehension tables generated by the server device 10 based on the change history data. Note that the comprehension table will be described later.

The recording medium 16 is a non-volatile and non-transitory recording medium such as a disc-shaped recording medium or a semiconductor memory. The recording medium 16 may be detachably formed to the server device 10. The recording medium 16 records various programs executed by the processor 11.

### (Terminal Device)

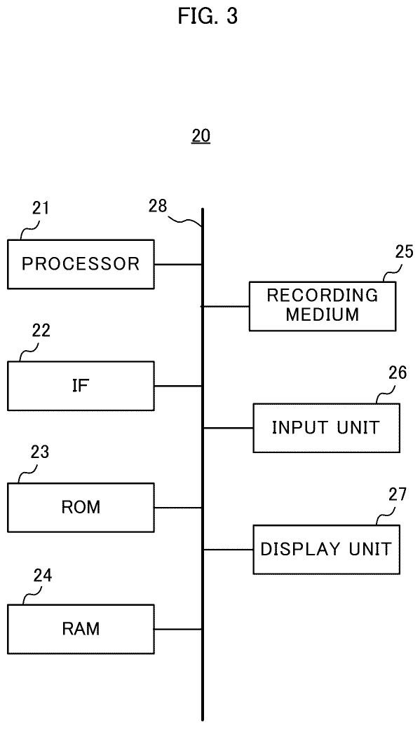

FIG. 3 is a block diagram illustrating a hardware configuration of the terminal device 20. The terminal device 20 is, for instance, a PC or a tablet terminal. As illustrated in FIG. 3, the terminal device 20 includes a processor 21, an IF 22, a ROM 23, a RAM 24, an input unit 26, and a display unit 27. These components are mutually connected, for instance, through a bus 28.

The processor 21 is a computer such as a CPU, and controls the entire terminal device 20 by executing programs prepared in advance. The processor 21 may be a GPU, FPGA, DSP, ASIC or the like.

The IF 22 transmits and receives data to and from an external device. Specifically, the terminal device 20 transmits the change history data created by the user during the software development, the prompt including an instruction to create a comprehension table, and the like, to the server device 10 through the IF 22. The ROM 23 stores various programs executed by the processor 21. Also, the RAM 24 is used as a working memory during various operations performed by the processor 21.

A recording medium 25 is a non-volatile and non-transitory recording medium such as a disc-shaped recording medium or a semiconductor memory. The recording medium 25 may be detachably formed to the terminal device 20. The recording medium 25 records various programs executed by the processor 21.

The input unit 26 is, for instance, an input device such as a keyboard, a mouse, or a touch panel. The user inputs a prompt including the instruction for creating the comprehension table, a question concerning software under development, and the like. The display unit 27 is a display or the like for displaying information based on a control of the processor 21. An answer to the question input by the user is displayed on the display unit 27 and presented to the user.

### [Function Configuration]

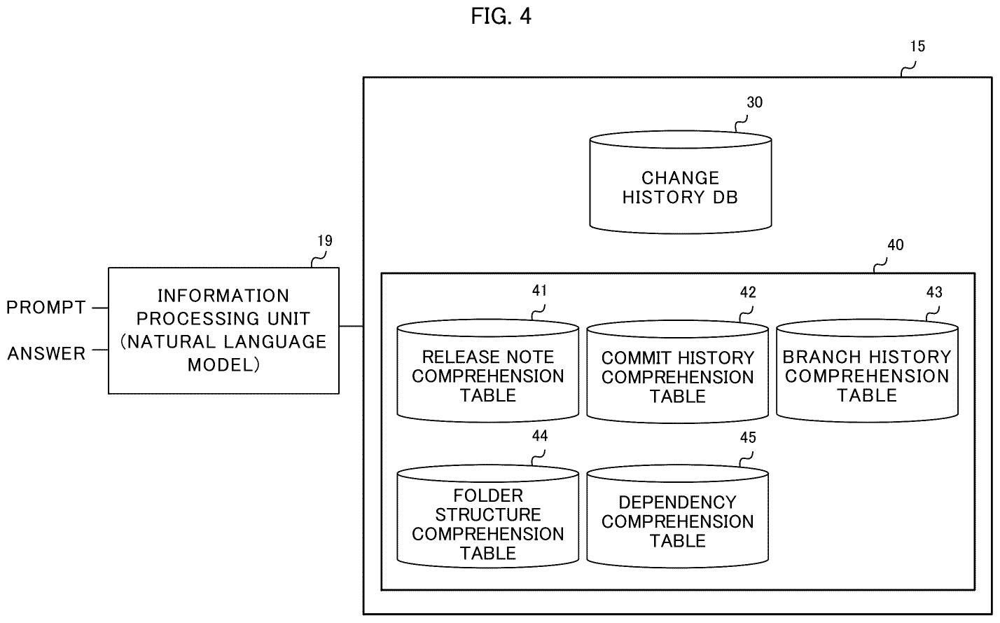

FIG. 4 is a block diagram illustrating a functional configuration of the server device 10. The server device 10 functionally includes an information processing unit 19. Also, the DB 15 includes a change history DB 30 and a comprehension table DB 40. The comprehension table DB 40 includes a release note comprehension table 41, a commit history comprehension table 42, a branch history comprehension table 43, a folder structure comprehension table 44, and a dependency comprehension table 45.

The change history DB 30 stores the change history data. The change history data are data stored in the repository in the server device 10 in a case where the user changes or edits the software using Git. Specifically, the change history data includes release note data, commit history data, branch history data, folder structure data, etc., as data generated in the program development.

The information processing unit 19 generates the comprehension table based on the prompt from the user. The comprehension table refers to a table that explains a meaning and relevance of data in a database. The information processing unit 19 stores the generated comprehension table in the comprehension table DB 40. As shown in FIG. 4, in the present example embodiment, the comprehension table includes the release note comprehension table 41, the commit history comprehension table 42, the branch history comprehension table 43, the folder structure comprehension table 44, and the dependency comprehension table 45.

Specifically, the information processing unit 19 acquires a prompt which is input by the user to create the comprehension table. This prompt includes a designation of the data for which the comprehension table is to be created and the instruction for creating the comprehension table concerning the data designated. For instance, in a case of creating the comprehension table of the commit history, the user enters a prompt such as “Create a comprehension table of the commit history using the commit history data.”

The information processing unit 19 includes the natural language model. The information processing unit 19 interprets the prompts using the natural language model and acquires the designated data from the change history DB 30. Next, the information processing unit 19 organizes data acquired for each item of the comprehension table to be created, creates the comprehension table, and stores the comprehension table in the comprehension table DB 40. Accordingly, the comprehension table for each of the various types of the data is created. Each comprehension table is a table that organizes each of the change history data in order to explain a meaning and relevance of the change history data. Therefore, by referring to each comprehension table, details of changes made by each user can be learned more easily than by tracking the change history data in the change history DB 30.

### Example of Comprehension Table

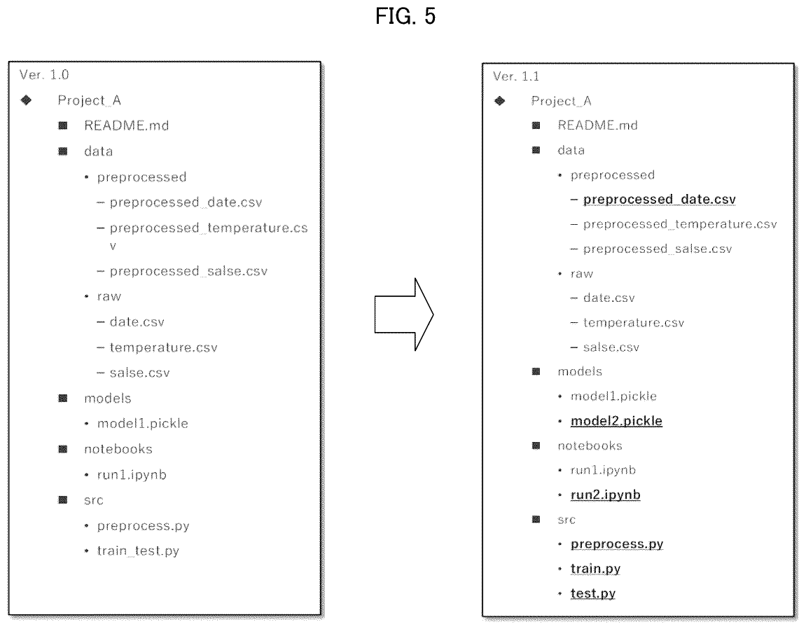

Next, an example of the comprehension table will be described. As an example of prerequisite the software development, a project of “Project_A” is considered for developing a machine learning model to predict a demand for a product A. It is assumed that the machine learning model designed to predict the demand for the product A (hereinafter, a simply “demand prediction model”) is created as a version 1.1 based on an initial version 1.0. FIG. 5 illustrates respective folder structures of the version 1.0 and the version 1.1 of the demand prediction model. Note that files that have been changed in the version 1.1 are underlined in the folder structure of the version 1.1. The change history data concerning related to the version 1.0 and the version 1.1 are stored in the change history DB 30.

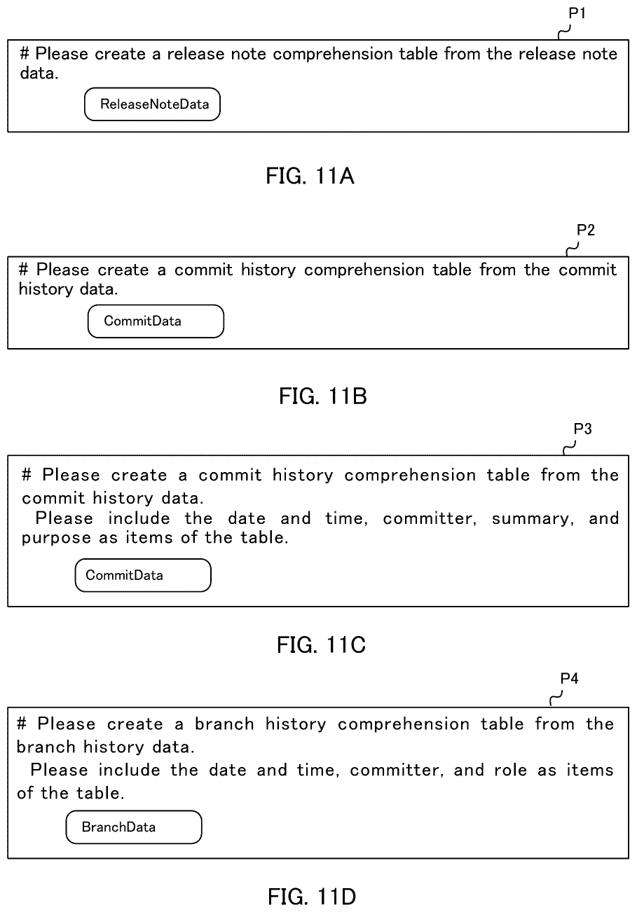

In a case of creating a release note comprehension table, the user creates a prompt P1 shown in FIG. 11A and transmits the prompt P1 to the server device 10. The prompt P1 specifies the release note data as target data and includes an instruction for creating the release note comprehension table. The information processing unit 19 of the server device 10 interprets the prompt P1 using the natural language model and acquires the release note data of the Project_A from the change history DB 30. Next, the information processing unit 19 organizes and formats the acquired release note data into a table, creates the release note comprehension table 41, and stores the created release note comprehension table 41 in the comprehension table DB 40. Note that in a case where an old release note comprehension table 41 already exists, the information processing unit 19 may update the release note comprehension table 41 using the created release note comprehension table.

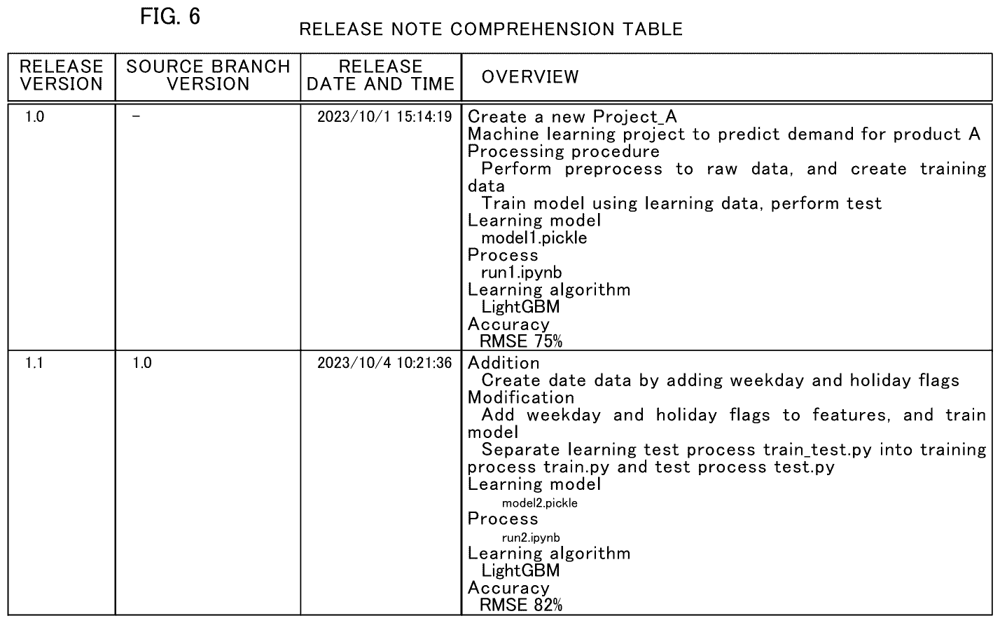

FIG. 6 shows an example of the release note comprehension table. The release note comprehension table 41 includes items of “RELEASE VERSION,” “SOURCE BRANCH VERSION,” “RELEASE DATE AND TIME,” and “OVERVIEW.” Note that as “branch” refers to program codes created by branching from the main history or a process of creating those program codes, for the development of a different version or function of a project.

In a case of creating a commit history comprehension table, the user creates a prompt P2 shown in FIG. 11B, for instance, and transmits the prompt P2 to the server device 10. The prompt P2 specifies the commit history data as the target data and includes an instruction for creating the commit history comprehension table. The information processing unit 19 interprets the prompt P2 using the natural language model and acquires the commit history data of the Project_A from the change history DB 30. Then, the information processing unit 19 organizes and formats the acquired commit history data into a table, creates the commit history comprehension table 42, and stores the created commit history comprehension table 42 in the comprehension table DB 40. Note that in a case where an old commit history comprehension table 42 already exists, the information processing unit 19 may update the commit history comprehension table 42 using the created commit history comprehension table.

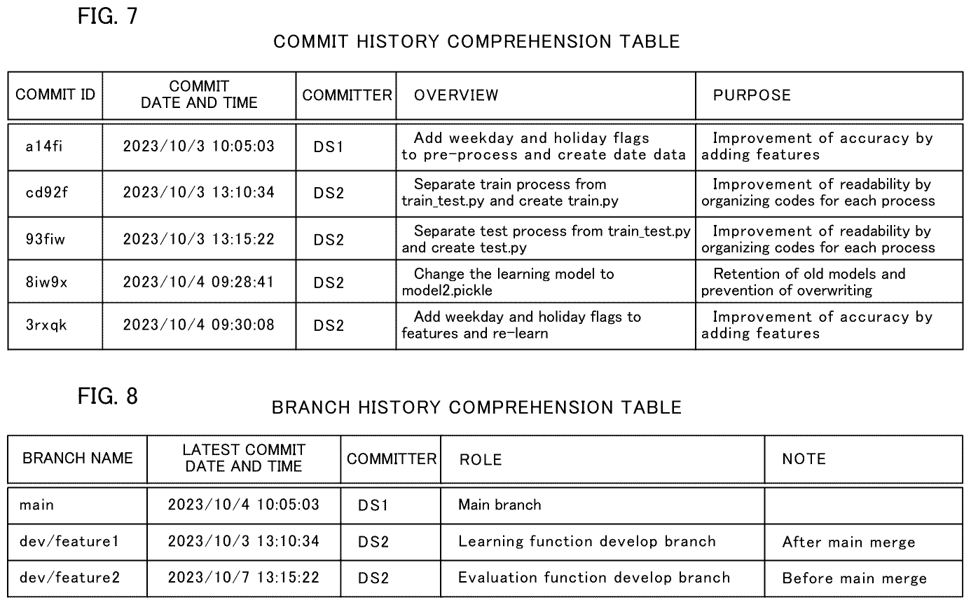

FIG. 7 shows an example of the commit history comprehension table. The commit history comprehension table 42 includes items of “COMMIT ID,” “COMMIT DATE AND TIME,” “COMMITTER,” “OVERVIEW,” and “PURPOSE.” The item of “COMMIT ID” indicates identification information of a commit operation, the item of “COMMIT DATE AND TIME” indicates a date and time in a case where the commit was made, and the item of “COMMIT” indicates identification information of the user who performed the commit operation. The item of “OVERVIEW” indicates a work content of each commit, and the item of “PURPOSE” indicates a reason why the committer made that commit. Note that the information processing unit 19 can generate the “OVERVIEW” and “PURPOSE” based on a commit message included in the commit history of Git.

Note that in a case where the user desires to specify a structure of the comprehension table to be created, in particular, items included in the comprehension table, the user can include a designation of the items in the prompt. For instance, in a case where the user desires to create the commit history comprehension table as illustrated in FIG. 7, the user may designate the items to be included in the comprehension table in the prompt as in a prompt P3 in FIG. 11C. In this case, the information processing unit 19 extracts data corresponding to the items designated in the prompt from the change history data, and organizes the extracted data to create the comprehension table.

In a case of creating a branch history comprehension table, a user creates a prompt P4 shown in FIG. 11D, for instance, and transmits the prompt P4 to the server device 10. The prompt P4 specifies the branch history data as the target data and includes an instruction for creating the branch history comprehension table. The information processing unit 19 interprets the prompt P4 using the natural language model, and acquires the branch history data of the Project_A from the change history DB 30. Next, the information processing unit 19 organizes and formats the acquired branch history data into a table, creates the branch history comprehension table 43, and stores the created branch history comprehension table 43 in the comprehension table DB 40. Note that in a case where an old branch history comprehension table 43 already exists, the information processing unit 19 may update the branch history comprehension table 43 using the created branch history comprehension table.

FIG. 8 shows an example of the branch history comprehension table. The branch history comprehension table 43 includes “BRANCH NAME,” “LATEST COMMIT DATE AND TIME,” “COMMITTER,” “ROLE,” and “NOTE” as items. The item of “BRANCH NAME” indicates a name given to the branch, the item of “LATEST COMMIT DATE AND TIME” indicates a date and time in a case where the latest commit was made in each branch, and the item of “COMMITTER” indicates the identification information of the user who performed a commit work. The item of “ROLE” indicates a role of the branch, and the item of “NOTE” indicates a supplementary explanation for each branch.

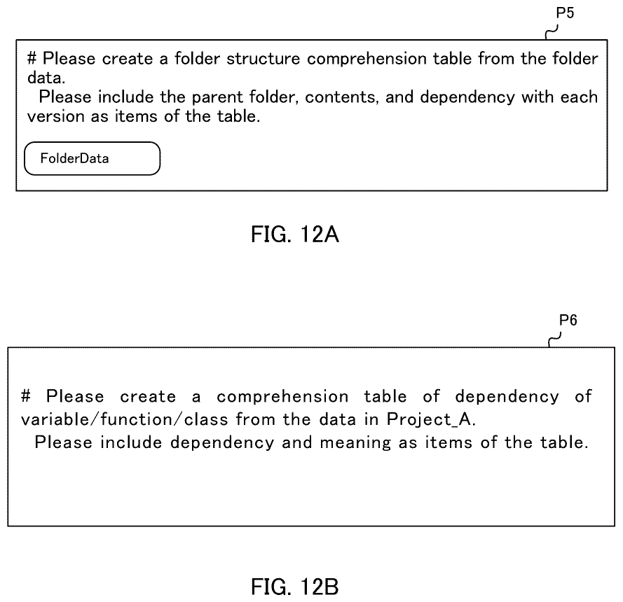

In a case of creating a folder structure comprehension table, the user creates a prompt P5 shown in FIG. 12A and transmits the created prompt P5 to the server device 10. The prompt P5 specifies the folder structure data as the target data and includes an instruction for creating the folder structure comprehension table. The information processing unit 19 interprets the prompt P5 using the natural language model and acquires the folder structure data of the Project_A from the change history DB 30. Next, the information processing unit 19 organizes and formats the acquired folder structure data into a table, creates the folder structure comprehension table 44, and stores the created folder structure comprehension table 44 in the comprehension table DB 40. Note that in a case where an old folder structure comprehension table 44 already exists, the information processing unit 19 may update the folder structure comprehension table 44 using the created folder structure comprehension table.

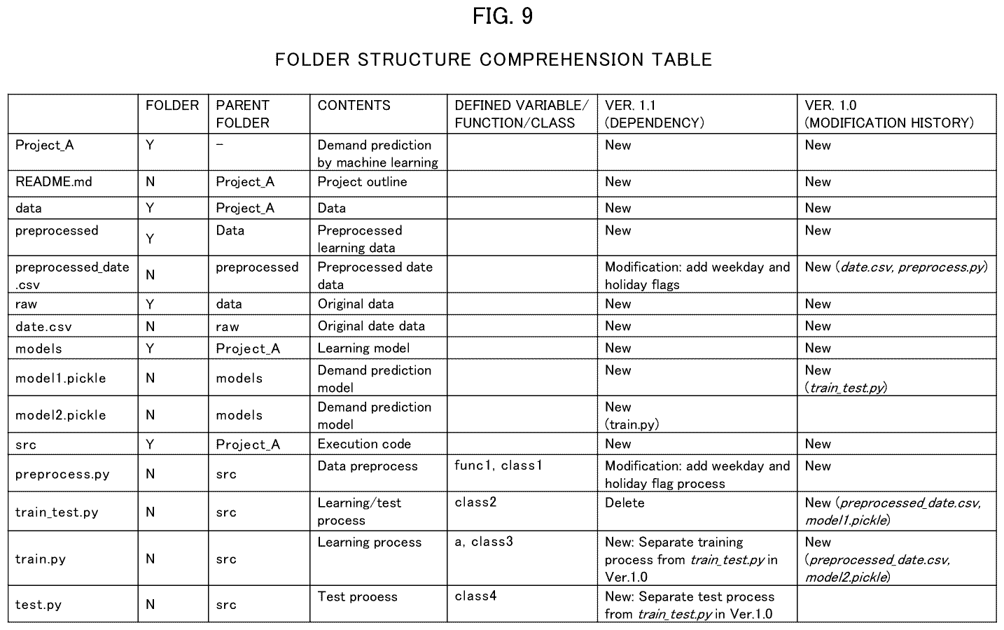

FIG. 9 shows an example of a folder structure comprehension table. The folder structure comprehension table 44 includes “NAME”, “FOLDER”, “PARENT FOLDER”, “CONTENTS”, “DEFINED VARIABLE/FUNCTION/CLASS”, “VER. 1.1 (DEPENDENCY)”, and “VER. 1.0 (DEPENDENCY)” as items. The item of “NAME” indicates a name of the folder or file. The item of “FOLDER” indicates identifications of the folder and a file. Specifically, “Y” indicates the folder, and [N] indicates the file. Note that whether the folder or the file is determined from properties of a file system, for instance. The item of “PARENT FOLDER” indicates a name of a parent folder of that folder. The item of “CONTENTS” refers to a description of data included in the folder or file and a usage of the folder or file. The item of “DEFINED VARIABLE/FUNCTION/CLASS” indicates a variable, function, or class defined in the file. Each of the items of “VER. 1.1 (DEPENDENCY)” and “VER. 1.0 (DEPENDENCY)” indicates a dependency or correspondence between versions of the respective folders or files.

In a case of creating a dependency comprehension table, the user creates a prompt P6 shown in FIG. 12B, for instance, and transmits the prompt P6 to the server device 10. The prompt P6 specifies a project as the target data and an instruction for creating the dependency comprehension table. The information processing unit 19 interprets the prompt P6 using the natural language model, and acquires variable data, function data, and class data for the specified project from the change history DB 30. Next, the information processing unit 19 organizes and formats the acquired data into a table, and creates the dependency comprehension table 45 and stores the created dependency comprehension table 45 in the comprehension table DB 40. Note that in a case where an old dependency comprehension table 45 already exists, the information processing unit 19 may update the dependency comprehension table 45 using the created dependency comprehension table.

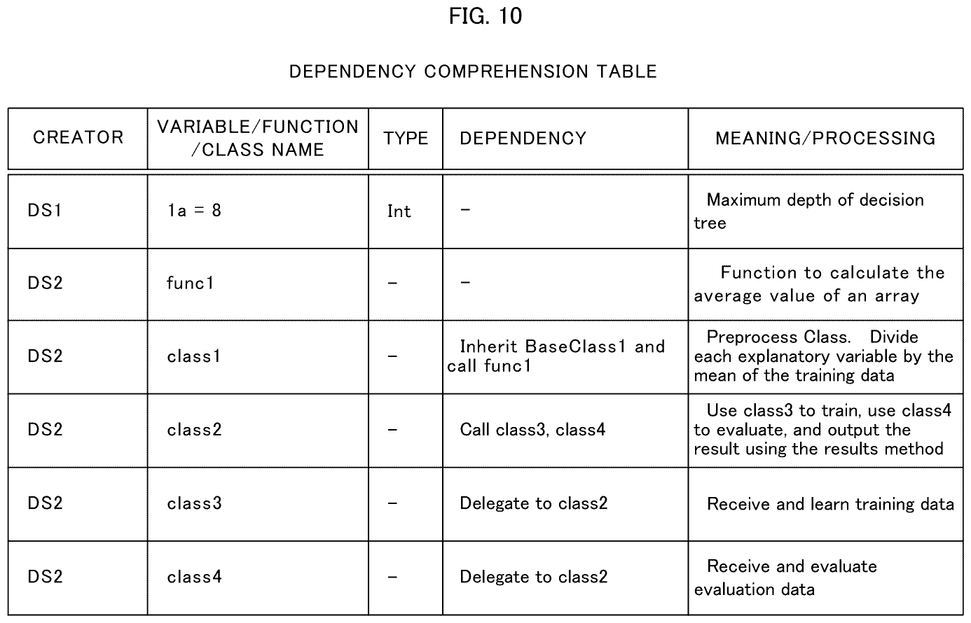

FIG. 10 shows an example of the dependency comprehension table. The dependency comprehension table 45 includes “CREATOR”, “VARIABLE/FUNCTION/CLASS NAME”, “TYPE”, “DEPENDENCY”, “MEANING/PROCESSING” as items. The item of “CREATOR” indicates identification information of a creator of a variable, function, or class. The item of “VARIABLE/FUNCTION/CLASS NAME” indicates a name of the variable, function, or class. The item of “TYPE” indicates a data type of the variable. The item of “DEPENDENCY” indicates a dependency with another variable, function, or class. The item of “MEANING/PROCESSING” indicates a meaning of the variable, function, or class a processing using the variable, function, or class.

As described above, in the present example embodiment, the server device creates and stores the comprehension table from a different viewpoint such as the commit history and the folder structure, from the change history data accumulated in a case where the program is changed or edited using Git. Accordingly, the information processing unit 19 has understood the change history DB 30, that is, the contents of a Git repository, in the form of the comprehension table, and thereafter the user can inquire or ask the information processing unit 19 concerning the Git repository.

### [Comprehension Table Creation Process]

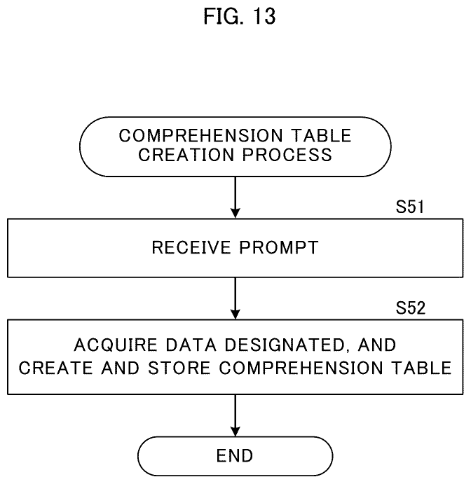

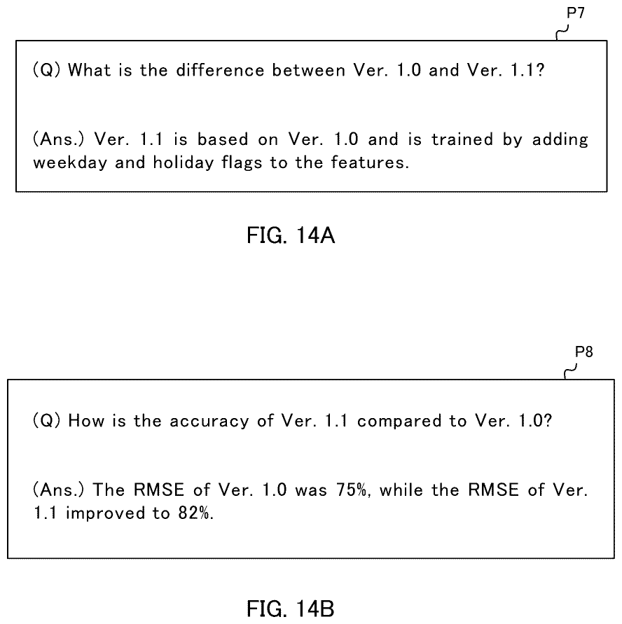

FIG. 13 shows a flowchart of a comprehension table creation process. The comprehension table creation process is a process of creating the comprehension table based on the change history data as described above. This comprehension table creation process is realized by the processor 11 shown in FIG. 2 which executes a program prepared in advance, and operates as an information processing unit 19 shown in FIG. 14. The comprehension table creation process is performed in a case of creating a new comprehension table and in a case of updating or revising an existing comprehension table. Note that the “update” refers to overwrite the created comprehension table with the new comprehension table. In addition, the “revision” refers to retain the comprehension table (that is, corresponding to the version 1.0) which has already been created, and create the new comprehension table (that is, corresponding to the version 1.1).

First, in response to an input of the prompt by the user, the information processing unit 19 receives that prompt (step S51). Next, the information processing unit 19 acquires the data designated in the prompt from the change history DB 30, creates the comprehension table, and stores the created comprehension table in the comprehension table DB 40 (step S52). Note that the information processing unit 19 may refer to other comprehension tables which have already been created in a case of creating the comprehension table. The comprehension table creation process is terminated.

### Example of Using Comprehension Table

Next, an example of using the comprehension table will be described. The comprehension table is described in a natural language, and the information processing unit 19 of the server device 10 includes the natural language model. Therefore, it is possible for the information processing unit 19 to receive a question or a query described in the natural language from the user, generate an answer by referring to the comprehension table, and send the generated answer to the user. Accordingly, it is possible for the user to make the question in the natural language with respect to the server device 10 in a case where the user who is unable to handle the program code desires to know a state of the software development.

For instance, in a case where the user desires to know a difference between the version 1.0 and the version 1.1 in the Project_A described above, the user generates a prompt P7 of a question as illustrated in FIG. 14A, and transmits the generated prompt P7 to the server device 10. The prompt P7 inquires for the difference between version 1.0 and version 1.1 in the Project_A described above. In a response to receiving the prompt P7, the information processing unit 19 refers to the release note comprehension table shown in FIG. 6, the commit history comprehension table shown in FIG. 7, the folder structure comprehension table shown in FIG. 9, and the like, determines “the version 1.1 is based on the version 1.1 and has learned by adding weekday and holiday flags to the features,” and can generate an answer as shown in FIG. 14A.

Moreover, as illustrated in FIG. 14B, in a case where the user has inquired concerning accuracies of the version 1.0 and the version 1.1, the information processing unit 19 determines “RMSE has improved from 75% to 82%” by referring to the release note comprehension table and the like illustrated in FIG. 6, and can generate an answer as illustrated in FIG. 14B.

Alternatively, it is possible for the user to designate a particular commit by the commit ID, the commit date and time, and the like, inquire the purpose of that particular commit, inquire the meaning of a variable or class by specifying the variable or class.

Moreover, by providing a specific process function to the natural language model provided by the information processing unit 19, it is also possible to request a specific process concerning the comprehension table. For instance, a function of organizing (refactoring) the folder structure or the file is assigned with respect to the natural language model included in the information processing unit 19. The user makes an instruction of refactoring regarding a specific folder or the entire folder structure in the change history DB 30 by the prompt. By receiving the instruction of refactoring regarding the folder structure, the information processing unit 19 can comprehend the folder structure in the change history DB 30 by referring to the folder structure comprehension table and the like, and perform the refactoring of the folder structure.

### Modifications

Next, modifications of the above example embodiment will be described. The following modifications can be applied in combination as appropriate.

### Modification 1

In the example embodiment described above, a plurality of users are cooperatively modifying or editing a program; however, even in a case where a single user modifies or edits the program, the present example embodiment can be similarly applied.

### Modification 2

In the example embodiment described above, Git is used as the software development support system, but in a cased where the system accumulates history data of program changes, editing, and the like, other systems may be used.

### Second Example Embodiment

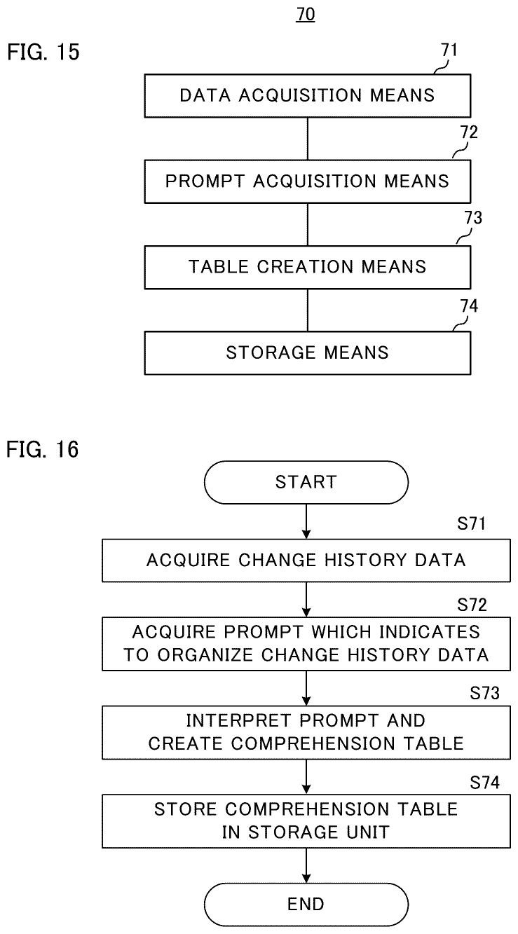

FIG. 15 is a block diagram illustrating a functional configuration of the information processing device according to a second example embodiment. The information processing device 70 includes a data acquisition means 71, a prompt acquisition means 72, a table creation means 73, and a storage means 74.

FIG. 16 is a flowchart of a process performed by the information processing device according to the second example embodiment. The data acquisition means 71 acquires the change history data related to the change of the software (step S71). The prompt acquisition means 72 is described in the natural language and acquires the prompt to instruct the creation of the comprehension table from the change history data (step S72). The table creation means 73 interprets the prompt using the natural language model and creates a comprehension table based on the change history data (step S73). The storage means 74 stores the comprehension table in a storage unit (step S74).

According to the information processing device 70 of the second example embodiment, it is possible to organize and manage information concerning the change histories in the software development.

A part or all of the example embodiments described above may also be described as the following supplementary notes, but not limited thereto.

### (Supplementary Note 1)

1. An information processing device comprising:
a data acquisition means configured to acquire change history data concerning a change of software;
a prompt acquisition means configured to acquire a prompt which is described and instructs to create a comprehension table based on the change history data;
a table creation means configured to interpret the prompt using a natural language model and create a comprehension table based on the change history data; and
a storage means configured to store the comprehension table in a storage unit.

### (Supplementary Note 2)

2. The information processing device according to supplementary note 1, wherein the comprehension table includes a comprehension table of each change history of the software, and a comprehension table of a folder structure for storing data concerning the software.

### (Supplementary Note 3)

3. The information processing device according to supplementary note 1, wherein
the change history data are generated using Git; and
the comprehension table includes a commit history comprehension table and a folder structure comprehension table.

### (Supplementary Note 4)

4. The information processing device according to supplementary note 3, wherein the comprehension table includes a release note comprehension table and a branch history comprehension table.

### (Supplementary Note 5)

5. The information processing device according to supplementary note 4, wherein the comprehension table includes a dependency comprehension table which indicates each dependency among names of a variable, a function, and a class.

### (Supplementary Note 6)

6. The information processing device according to supplementary note 1, wherein the prompt includes an instruction of each item to be included in the comprehension table to be created.

### (Supplementary Note 7)

7. The information processing device according to supplementary note 1,
wherein the comprehension table is described in the natural language, and
wherein the information processing device further comprises:
a question acquisition means configured to acquire a question described in the natural language; and
an answer means configured to interpret the question using the natural language, generate an answer with respect to the question by referring to the comprehension table, and output the answer generated.

### (Supplementary Note 8)

8. The information processing device according to supplementary note 1,
wherein the comprehension table includes a folder structure comprehension table described in the natural language, and
wherein the information processing device further comprises:
a question acquisition means configured to acquire an instruction which is described in the natural language and indicates to organize a folder structure; and
an organization means configured to interpret the instruction using the natural language and organize the folder structure of the change history data. (Supplementary Note 9)
9. An information processing method performed by a computer and comprising:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.

### (Supplementary Note 10)

10. A program causing a computer to execute processing of:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2023-219312, filed on Dec. 26, 2023, the disclosure of which is incorporated herein in its entirety by reference.

### DESCRIPTION OF SYMBOLS

10 Server device
11 Processor
19 Information processing unit
20 Terminal device
30 Change history DB
40 Comprehension table DB
41 Release note comprehension table
42 Commit history comprehension table
43 Branch history comprehension table
44 Foder structure history comprehension table
Dependency comprehension table

1. An information processing device comprising:
at least one memory configured to store instructions; and
at least one processor configured to execute the instructions to:
acquire change history data concerning a change of software;
acquire a prompt which is described and instructs to create a comprehension table based on the change history data;
interpret the prompt using a natural language model and create a comprehension table based on the change history data; and
store the comprehension table in a storage unit.

2. The information processing device according to claim 1, wherein the comprehension table includes a comprehension table of each change history of the software, and a comprehension table of a folder structure for storing data concerning the software.

3. The information processing device according to claim 1, wherein
the change history data are generated using Git; and
the comprehension table includes a commit history comprehension table and a folder structure comprehension table.

4. The information processing device according to claim 3, wherein the comprehension table includes a release note comprehension table and a branch history comprehension table.

5. The information processing device according to claim 4, wherein the comprehension table includes a dependency comprehension table which indicates each dependency among names of a variable, a function, and a class.

6. The information processing device according to claim 1, wherein the prompt includes an instruction of each item to be included in the comprehension table to be created.

7. The information processing device according to claim 1,
wherein the comprehension table is described in the natural language, and
wherein the processor is further configured to
acquire a question described in the natural language; and
interpret the question using the natural language, generate an answer with respect to the question by referring to the comprehension table, and output the answer generated.

8. The information processing device according to claim 1,
wherein the comprehension table includes a folder structure comprehension table described in the natural language, and
wherein the processor is further configured to
acquire an instruction which is described in the natural language and indicates to organize a folder structure; and
interpret the instruction using the natural language and organize the folder structure of the change history data.

9. An information processing method performed by a computer and comprising:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.

10. A non-transitory computer-readable recording medium storing a program causing a computer to execute processing of:
acquiring change history data concerning a change of software;
acquiring a prompt which is described and instructs to create a comprehension table based on the change history data;
interpreting the prompt using a natural language model and creating a comprehension table based on the change history data; and
storing the comprehension table in a storage unit.
